(19) United States
(12) Patent Application Publication
(10) Pub. No.: US 2022/0228424 A1
(43) Pub. Date: Jul. 21, 2022

(54) DOOR CONSTRUCTION FOR A PORTABLE BUILDING DOOR

(71) Applicant: Joseph MARTENS, Stonefort, IL (US)

(72) Inventor: Joseph MARTENS, Stonefort, IL (US)

(21) Appl. No.: 17/153,017

(22) Filed: Jan. 20, 2021

(51) Int. Cl. E06B 3/48; E04B 1/343

(52) U.S. Cl. CPC E06B 3/483; E04B 2001/34389; E04B 1/34321

(57) ABSTRACT

A door (10) comprising a door member having a rectangular frame (22) on which components forming the door member are assembled. The frame includes top, side and a bottom frame member (24, 26a, 26b, 28). The frame is sized and shaped to fit within an opening (P) in a sidewall (S) of a portable building (B). A foam panel (16) fits in the frame. Door panels (12, 14) are affixed to the outsides of the foam panel using an adhesive material. The result is a laminated door that can be lowered and raised for moving people and objects into and out of the building.

### CROSS-REFERENCE TO RELATED APPLICATIONS

United States design patent application 29/717,768.

### STATEMENT REGARDING FEDERALLY SPONSORED RESEARCH OR DEVELOPMENT

Not Applicable.

### BACKGROUND OF THE INVENTION

This invention relates to portable buildings; and, more particularly, to the construction of a door installed in a sidewall of such buildings and which is lowered from a vertical or upright closed position to an inclined open position in which the door serves as a ramp for enabling people and objects to be moved into and out of the building.

Portable buildings are known in the art. These typically include a roof, four sidewalls and a floor. Skids are installed beneath the floor for moving the building from one location to another. It is also known to install doors in a side of the building with the door being movable from a closed vertical or upright position to an inclined open position in which the door functions as a ramp. This facilitates the movement of people and equipment into and out of the building.

It will be appreciated that these types of doors are subject to significant amounts of stress and strain giving the amount of weight to which the door is subjected when functioning as a ramp not only because of the ingress and egress of people, but also the types and amount of equipment and materials which are also moved into and out of the building using the ramp. It is important therefore that the door be constructed not only to support this weight, but also that the door not be distorted through use so that it continues to properly seal the opening in the side of the building when closed, and that, when closed, it remains relatively air tight and does not leak. This latter is important because if there is leakage, for example, there may be water damage to the contents stored in the building, or dirt and debris may be blown into the building contaminating or damaging the stored contents.

What is needed is a door whose construction is such as to properly function as desired, not be compromised during normal usage, and which has an exterior appearance in keeping with the building's aesthetic.

### BRIEF SUMMARY OF THE INVENTION

A door for installation in the sidewall of a portable building includes a rectangular frame on which components forming the door are assembled. An insulation foam panel is sized and shaped to fit within the frame. First and second exterior door panels are each sized and shaped to conform to the size and shape of the foam panel and are affixed to respective sides of the foam panel. The foam panel, together with the exterior door panels and the frame, form a laminated door that fits within an opening in the sidewall.

The door is connected to a mechanism for lowering and raising the door. In operation, the mechanism lowers the door from an upright, vertical position to an inclined open position with the door then forming a ramp for moving people and objects into and out of the building. The door is constructed so that it does not bow or sag. The door may flex slightly when significant amounts of weight are moved over the ramp, but the door returns to its original configuration when the weight is removed. This allows greater weight to be moved over the ramp than otherwise might be possible. Also, the door does not leak when it is closed so water, dirt, or other contaminants are kept out of the building

Other objects and features will be in part apparent and in part pointed out hereinafter.

### BRIEF DESCRIPTION OF THE DRAWINGS

FIG. 1 is an elevation view of a portable building having a first embodiment of a door constructed in accordance with the present invention;

FIG. 2 is a view similar to FIG. 1 having a second embodiment of a door constructed in accordance with the present invention;

FIG. 3 is a front elevation view of a door of the present invention partially constructed; and

FIG. 4 is a side elevation view of the door.

Corresponding reference numerals will be used throughout the several figures of the drawings.

### DETAILED DESCRIPTION OF THE INVENTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

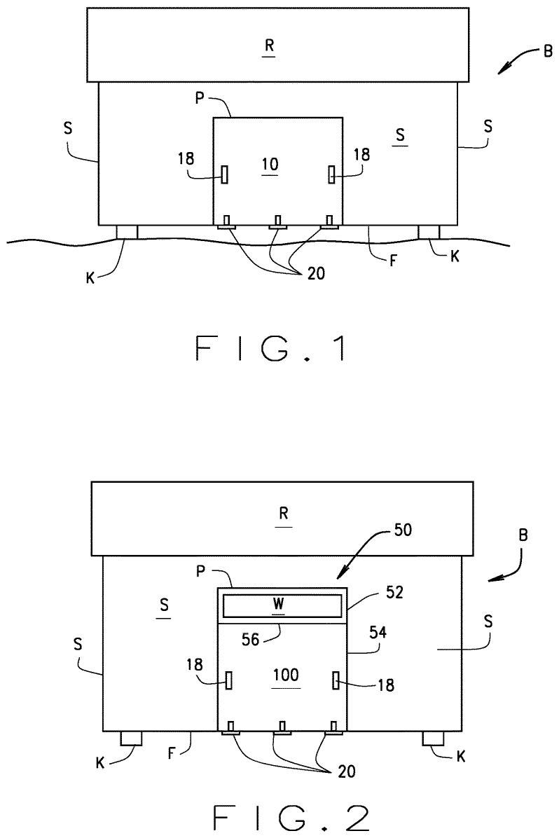

Referring to the drawings, a portable building B has sidewalls S, a roof R, a floor F, and at least one skid K installed beneath the floor for moving the building from one location to another. As shown in the drawings, building B is equipped with two skids K. A rectangular opening P for a door is formed in at least one side S of building B. As shown in FIG. 1, a first embodiment of a door 10 made in accordance with the present invention is installed in opening P. As shown in FIG. 2, a window W may be installed above the door which is now generally indicated 100.

Referring to FIG. 4, a door 10 includes a door member having an exterior cover panel 12 comprising either a wood siding material or a composite siding material. Panel 12 is made of a treated wood siding material which is water resistant. A wooden plywood panel 14 is used as an interior cover panel for the door. A water-proof foam insulation panel 16 is laminated, as will be described, between the exterior and interior panels 12, 14 to provide rigidity to the door when door 10 is in its lowered, open position and used as a ramp to move people, equipment, materials, and other objects into and out of building B. A door handle 18 is fitted to exterior panel 12 of the door member, and spaced supports comprised of rotatable t-hinges 20 (three of which are shown in FIGS. 1 and 2) are attached to panel 12 at the base of the panel. Each t-shaped support has a base fitting beneath the bottom of the door as shown in FIGS. 4 and 5, and a vertical leg extending upwardly along the exterior of the door panel 12 forming the outside of door 10 when the door member is installed in building B.

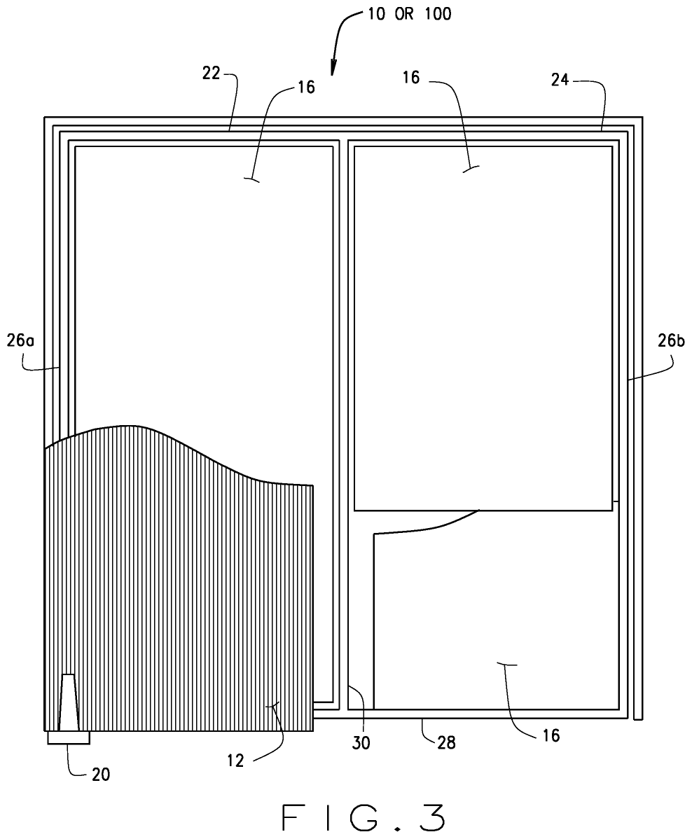

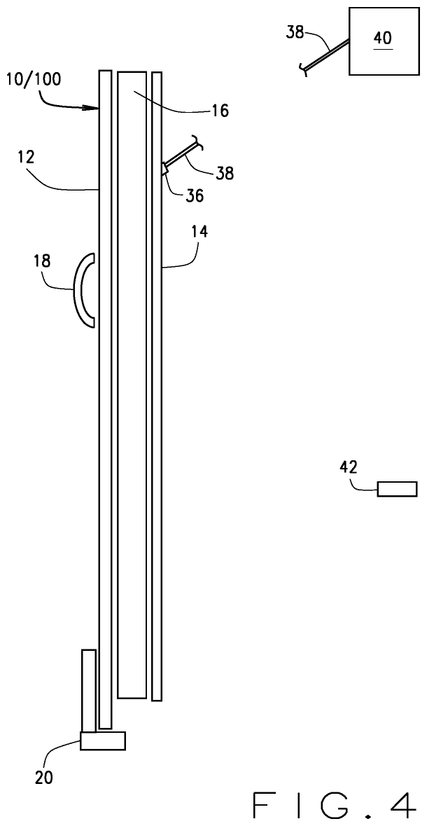

Referring now to FIG. 3, the door member of door 10 includes a rectangular frame 22 on which components forming the door are assembled. Frame 22 has a top frame member 24, respective side frame members 26a, 26b, and a bottom frame member 28. The frame further includes a central, vertical frame member 30 which extends from top member 24 to bottom member 28. All of these frame members are either made of wood, metal, or a composite material.

Fitted within frame 22 are two rectangular shaped foam insulation panels 16 as previously identified. Both panels 16 are, for example, 1.5″ thick and sized and shaped to fit, in a side-by-side relationship, within the respective portions of frame 22 with the top, sides, and bottom of each panel abutting against the respective top, sides, and bottom surfaces of frame 22.

Finally, exterior door panel 12 and interior door panel 14 are sized and shaped to conform to outer dimensions of reinforcement 29 so to completely fit over the respective foam panels 16 and the sides of frame 22. In this regard, it will be understood that both the exterior and interior doors may be in two sections, with each section, when installed in a vertical side-by-side configuration, completely covering the respective side of the door. Further in this regard, and as shown in FIG. 4, exterior door panel 12 is longer than interior door panel 14 and foam panel 16. Further as shown in FIG. 4, while the upper ends of the panels 12, 14, and 16 are co-terminus, the lower end of exterior panel 12 extends below that of the other two panels so to facilitate the installation and functioning of the hinged supports 20.

When installing the exterior and interior panels 12, 14, a Loctite® type adhesive material is first spread over the entire outer surfaces of the foam panels 16 so the respective abutting surfaces of the exterior and interior door panels 12, 14 adhere to the respective surface of foam panel 16 when the panels 12, 14 are set in place. After exterior door panel 12 is installed, handle 18 is affixed to the outside of the panel in a convenient location for grasping by a user wanting to lower or raise the door. The t-hinges 20 are affixed to the base of panel 12 adjacent each side of the panel and in the middle of the panel. Adjacent each side of panel 14, toward the top of the panel, a connector 36 is attached. One end of a rope/wire 38 is attached to connector 36, the rope/wire 38 being part of a pulley system (not shown) such as is well-known in the art for use in facilitating the lowering and raising of door 10. The pulley system comprises part of an actuator or control mechanism 40 by which a motor or actuator (both not shown) installed within building B are electrically or electronically operated to control movement of the door. The motor or actuator may be battery powered and mechanism 40 is controllable by a handheld unit 42. Among other things, mechanism 40 may include a rotatable rod (not shown), a spool (also not shown) coupled to the rod, and a rope, chain, or wire wound on the spool and coupled to door 10 for moving the door in its opening or closing direction.

Once completed, door 10 comprises a laminated door which, when installed in opening P, can be lowered from an upright, vertical (door closed) position to an inclined (door open) position in which it forms a ramp for moving people and objects into and out of building B. Importantly, laminated door 10, when significant amounts of weight are moved over the ramp it forms, may slightly flex, but does not sag or break. This allows significantly more weight to be movable over the ramp than otherwise would be possible.

It will be understood that door 10 may have a decorative exterior appearance. That is, the exterior of the door may be painted, and/or it may have vertical, horizontal, or diagonal ornamental elements fitted to the outside of panel 12. One such example of such a decorative construction is shown in applicant's co-pending design patent application 29/717,768.

What has been described is a door 10 employing a laminated door member for use in a portable building B. Each door member has a reinforced frame with inner and outer door panels fitted over, and secured to, a foam center panel using an adhesive material. Hardware and decorative trim are affixed to or fitted to the exterior door panel. The laminated door of the present invention is capable of withstanding significant amounts of weight when used as a ramp when the door is in its open, lowered position. Door 10 is advantageous over use of a steel door, for example, because it is easier to install in a building B since to install a steel door in the building, which is typically made of wood, would require drilling holes into a side of the building for installing the door. An advantage to the construction of door 10 is that it requires no use of nails or screws to fabricate; and, when completed is significantly lighter in weight than a comparable steel door and is significantly cheaper as well.

In view of the above, it will be seen that the several objects and advantages of the present invention have been achieved and other advantageous results have been obtained.

As various changes could be made in the above constructions without departing from the scope of the invention, it is intended that all matter contained in the above description or shown in the accompanying drawings shall be interpreted as illustrative and not in a limiting sense.

1. In a portable building having sidewalls, a roof, a floor, and at least one skid installed beneath the floor for moving the building from one location to another, a door for installation in a rectangular opening formed in one of the building's sidewalls, comprising:
a door member having a rectangular frame on which components forming the door are assembled, the frame having a top frame member, respective side frame members, a bottom frame member, and a central frame member which extends vertically when the door is in an upright position, the central frame member extending from the top frame member to the bottom frame member, the frame being sized and shaped to fit within the opening in the sidewall of the building;
a rectangular shaped insulation foam panel sized and shaped to fit within the frame with a top, sides, and bottom of the panel abutting against the respective top, sides, and bottom surfaces of the frame, the foam panel not being offset from the frame when installed thereto;
first and second exterior door panels sized and shaped to conform to a size and shape of the foam panel, a first of the exterior door panels being affixed to one side of the foam panel with the second exterior door panel being affixed to the other side of the foam panel;
wherein the foam panel together with the first and second exterior foam panels, and the frame comprise a laminated door member that fits within the building sidewall; and,
wherein the door member, when installed, is lowered from an upright, vertical position to an inclined open position to form a ramp for moving people and objects into and out of the building with the foam panel, when significant amounts of weights are moved over the ramp, flexing, but not sagging or breaking, for more weight to be movable over the ramp than otherwise would be possible.

2. The door of claim 1 further including an adhesive applied to the entire surface of each side of the foam panel with the respective exterior door panels being attached to the respective side of the foam panel after the adhesive has been applied to that respective side of the foam panel.

3. The door of claim 1 further including a plurality of supports installed on an outer, exterior surface of the door member at intervals across the bottom of the door member.

4. The door of claim 3 in which each support is a t-shaped support with a base of the support fitting beneath the bottom frame member and a vertical leg of the support extending upwardly along the exterior door panel forming the outside of the door member when the door member is installed in the building, the door member being rotatable about the base of the supports.

5. The door of claim 4 in which the exterior door panel is longer than both the foam panel and interior door panel and extends below the bottom of each of these other panels to facilitate installation and operation of the supports.

6. The door of claim 1 wherein the exterior door panels are wood panels.

7. The door of claim 6 wherein the exterior door panel forming the outside of the door, when the door is installed in the building, is a decorated door panel.

8. The door of claim 1 further including an actuator mechanism connected to an inside surface of the door and a building member for the mechanism, when actuated, to lower the door from its closed position to an open position and return the door back from its open position to its closed position.
